(19) United States
(12) Patent Application Publication
(10) Pub. No.: US 2026/0150060 A1
(43) Pub. Date: May 28, 2026

(54) SETTING TRANSMISSION POWER BUDGETS WITH ADDED GRANULARITY

(71) Applicant: Cisco Technology, Inc., San Jose, CA (US)

(72) Inventors: Brian D. HART, Sunnyvale, CA (US); Sachin D. WAKUDKAR, St-Sulpice (CH); Nedime Pelin MOHAMED HASSAN SALEM, San Jose, CA (US)

(21) Appl. No.: 18/957,495

(22) Filed: Nov. 22, 2024

(51) Int. Cl. H04W 52/36; H04W 52/42

(52) U.S. Cl. CPC H04W 52/367; H04W 52/42

(57) ABSTRACT

The present disclosure describes a wireless network (e.g., a wireless fidelity (Wi-Fi) network) that reports allowed transmission powers for frequency ranges at a granularity less than 20 MegaHertz (MHZ). According to an embodiment, a network device includes one or more memories and one or more processors communicatively coupled to the one or more memories. The one or more processors, individually or collectively, determine a plurality of maximum transmission powers for a plurality of frequency ranges, generate a first message that includes (i) a field value indicating that the first message supports transmission powers for frequency ranges at a granularity below twenty MHz and (ii) a first maximum transmission power from the plurality of maximum transmission powers for a first frequency range at the granularity, and transmit the first message.

### TECHNICAL FIELD

Embodiments presented in this disclosure generally relate to wireless communications (e.g., wireless fidelity (Wi-Fi) communications). More specifically, embodiments disclosed herein relate to setting transmission powers for wireless communications with added granularity.

### BACKGROUND

A Wi-Fi network may use automated frequency coordination (AFC) to determine maximum transmission powers that can be used when transmitting in different frequency ranges to avoid interfering with incumbent devices. For example, an AFC system may report the maximum allowed transmission powers for different frequency ranges to the network, and the network may inform connecting devices of these maximum allowed transmission powers and their corresponding frequency ranges. Existing networks, however, may report the maximum allowed transmission powers to the devices with a lower granularity for the frequency ranges than the AFC system uses. For example, the AFC system may report the maximum allowed transmission powers for frequency ranges at a granularity of 1 MegaHertz (MHz) to 5 MHz. A network may report to a device the maximum allowed transmission powers for frequency ranges at a larger granularity of 20 MHz (or more). As a result, the network reports the lowest maximum allowed transmission power for a 20 MHz range from the AFC system as the maximum allowed transmission power for that range, even if the AFC system allows higher transmission powers for certain frequency ranges within that 20 MHz range. Consequently, the device may transmit using a lower power than allowed for certain frequencies within that 20 MHz range.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1A illustrates an example system.

FIG. 1B illustrates an example network controller, access point, or device in the system of FIG. 1A.

FIG. 2 illustrates an example operation performed by the system of FIG. 1A.

FIG. 3 illustrates an example message in the system of FIG. 1A.

FIG. 4 illustrates an example operation performed by the system of FIG. 1A.

FIG. 5 is a flowchart of an example method performed by the system of FIG. 1A.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

The present disclosure describes a wireless network (e.g., a wireless fidelity (Wi-Fi) network) that reports allowed transmission powers for frequency ranges at a granularity less than 20 MegaHertz (MHz). According to an embodiment, a network device includes one or more memories and one or more processors communicatively coupled to the one or more memories. The one or more processors, individually or collectively, determine a plurality of maximum transmission powers for wireless transmissions for a plurality of frequency ranges, generate a first message that includes (i) a field value indicating that the first message supports transmission powers for frequency ranges at a granularity below twenty MHz and (ii) a first maximum transmission power from the plurality of maximum transmission powers for a first frequency range at the granularity, and wirelessly transmit the first message.

According to another embodiment, a method includes determining a plurality of maximum transmission powers for a plurality of frequency ranges, generating a first message that includes (i) a field value indicating that the first message supports transmission powers for wireless transmissions for frequency ranges at a granularity below twenty MHz and (ii) a first maximum transmission power from the plurality of maximum transmission powers for a first frequency range at the granularity, and wirelessly transmitting the first message.

According to another embodiment, a non-transitory computer readable medium stores instructions that, when executed by one or more processors, cause the one or more processors to, individually or collectively, determine a plurality of maximum transmission powers for wireless transmissions for a plurality of frequency ranges, generate a first message that includes (i) a field value indicating that the first message supports transmission powers for frequency ranges at a granularity below twenty MHz and (ii) a first maximum transmission power from the plurality of maximum transmission powers for a first frequency range at the granularity, and wirelessly transmit the first message.

### Example Embodiments

The present disclosure describes a wireless network (e.g., a Wi-Fi network) that reports allowed transmission powers for frequency ranges at a granularity below 20 MHz. For example, the wireless network may report allowed transmission powers for frequency ranges at a granularity of 1 MHz. The wireless network may receive allowed transmission powers for frequency ranges from an automated frequency coordination (AFC) system. The wireless network may then generate a message that includes a field value that indicates that the wireless network supports allowed transmission powers for frequency ranges at a granularity less than 20 MHz. The message may also include the allowed transmission powers for certain frequency ranges. The wireless network may transmit the message to devices to inform the devices of the allowed transmission powers on the wireless network.

In certain embodiments, the wireless network provides several technical advantages. For example, by reporting allowed transmission powers for frequency ranges at a granularity below 20 MHz, the wireless network allows devices to transmit using higher transmission powers relative to existing networks that report allowed transmission powers at a granularity of 20 MHz or greater. As a result, the devices may use larger transmission powers without interfering with incumbent devices.

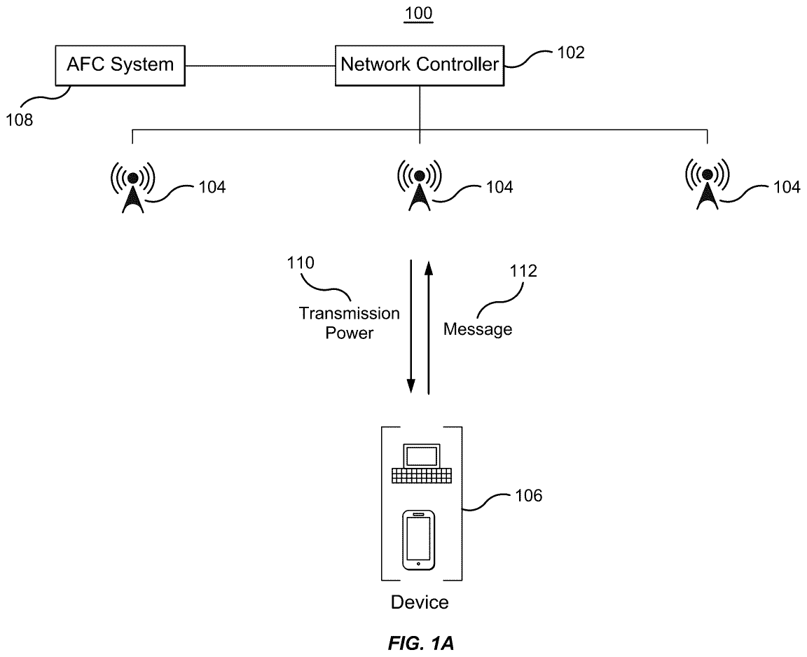

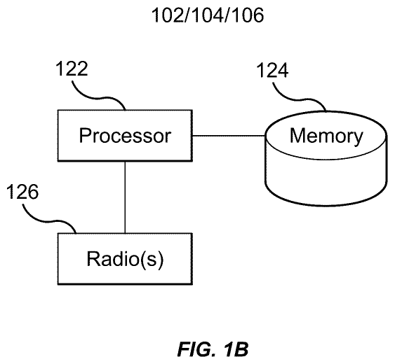

FIG. 1A illustrates an example system 100, which may be a wireless network (e.g., a Wi-Fi network). As seen in FIG. 1A, the system 100 includes one or more network devices. These network devices include one or more network controllers 102, one or more access points 104, and one or more devices 106. Generally, the network controller 102, if present, proxies the information from an AFC system to the access points 104. Generally, the access points 104 report allowed transmission powers to devices 106 for frequency ranges at a granularity less than 20 MHz (e.g., at 1 MHz). In some embodiments, the network controller 102 constructs the content of the messages for devices 106 on behalf of the access points 104 and sends such pre-formatted message content to the access points 104. The access points 104 then transmit the message content to the devices 106.

The network controller 102 facilitates or manages the communication in the system 100. The network controller 102 may instruct the access points 104 and/or device 106 to use certain communication parameters (e.g., channels, frequencies, bandwidths, transmission powers, etc.) when communicating with each other. For example, the network controller 102 may communicate, to an AFC system 108, the locations of the access points 104 (e.g., geolocation or coordinates of the access points 104). Generally, the AFC system 108 compares the locations of the access points 104 with the locations of incumbent devices in the area of the access points 104 to determine the maximum transmission powers that the access points 104 may use for various frequency ranges without interfering with the incumbent devices. The AFC system 108 may report, to the network controller 102, the maximum allowed transmission powers for the various frequency ranges. The network controller 102 may then inform the access points 104 of the maximum allowed transmission powers for these frequency ranges.

In some embodiments, the network controller 102 is integrated within one or more of the access points 104. In these implementations, the one or more access points 104 may be considered to perform the functions or features of the network controller 102. These one or more access points 104 may inform other access points 104 in the system 100 about the allowed maximum transmission powers. For example, these one or more access points 104 may communicate with the AFC system 108 to determine the maximum transmission powers for various frequency ranges. These one or more access points 104 may then direct messages to the device 106 to report the maximum transmission powers. These one or more access points 104 may also report the maximum transmission powers to other access points 104 in the system 100. In these embodiments, it may be considered that the one or more access points 104 perform the functions or features of the network controller 102 and that the system 100 does not include a separate network controller 102.

The access points 104 facilitate wireless communication (e.g., Wi-Fi communication) in the system 100. The device 106 may connect to an access point 104. The access point 104 may then facilitate wireless communication for the connected device 106. For example, the access point 104 may communicate, to the device 106, the allowed transmission powers 110 for various frequency ranges. These allowed transmission powers 110 may have been determined by and received from the AFC system 108.

Existing access points may report the allowed transmission powers for frequency ranges at a granularity of 20 MHz or more. As a result, the existing access points may report the allowed transmission power for a 20 MHz frequency range as the lowest allowed transmission power from the AFC system for a frequency that falls within that range, even if the AFC system allows a higher transmission power for another frequency in that range. For example, if the AFC system reports a higher allowed transmission power for the first 10 MHz of a 20 MHz range but a lower allowed transmission power for the last 10 MHz of the 20 MHz range, then the existing access point may report the lower transmission power for the entire 20 MHz range. Consequently, even though a device is allowed to use the higher transmission power for a significant portion of the 20 MHz range, the device is restricted to using the lower (and more generally the lowest) transmission power allowed for the 20 MHz range.

The network controller 102 and/or the access points 104 in the system 100 may report the allowed transmission powers 110 for frequency ranges at a granularity below 20 MHz (e.g., 1 MHz). As a result, the network controller 102 and/or the access points 104 may allow the devices 106 to use higher transmission powers than in existing systems.

The device 106 may be any suitable device that wirelessly connects to the access point 104. As an example and not by way of limitation, the device 106 may be a computer, a laptop, a wireless or cellular telephone, an electronic notebook, a personal digital assistant, a tablet, or any other device capable of receiving, processing, storing, or communicating information with other components of the system 100. The device 106 may be a wearable device such as a virtual reality or augmented reality headset, a smart watch, or smart glasses. The device 106 may also include a user interface, such as a display, a microphone, keypad, or other appropriate terminal equipment usable by the user. The device 106 may include a hardware processor, memory, or circuitry configured to perform any of the functions or actions of the device 106 described herein. For example, a software application designed using software code may be stored in the memory and executed by the processor to perform the functions of the device 106.

In operation, the network controller 102 receives, from the AFC system 108, the allowed transmission powers for various frequency ranges. For example, the AFC system 108 may report allowed transmission powers for every 1 MHz. The network controller 102 may report these allowed transmission powers and frequency ranges to the access points 104. An access point 104 then reports allowed transmission powers 110 to a device 106. The access point 104 may report these allowed transmission powers 110 for frequency ranges at a granularity less than 20 MHz that might be the same as sent by the AFC (e.g., 1 MHz) or at a coarser resolution (e.g., 2 or 5 MHz). The device 106 may then transmit a message 112 to the access point 104 according to the allowed transmission powers 110.

FIG. 1B illustrates an example network controller 102, access point 104, and/or device 106 in the system 100 of FIG. 1A. As seen in FIG. 1B, the network controller 102, access point 104, and/or device 106 includes a processor 122, a memory 124, and one or more radios 126.

The processor 122 is any electronic circuitry, including, but not limited to one or a combination of microprocessors, microcontrollers, application specific integrated circuits (ASIC), application specific instruction set processor (ASIP), and/or state machines, that communicatively couples to the memory 124 and controls the operation of the network controller 102, access point 104, and/or device 106. The processor 122 may be 8-bit, 16-bit, 32-bit, 64-bit or of any other suitable architecture. The processor 122 may include an arithmetic logic unit (ALU) for performing arithmetic and logic operations, processor registers that supply operands to the ALU and store the results of ALU operations, and a control unit that fetches instructions from memory and executes them by directing the coordinated operations of the ALU, registers and other components. The processor 122 may include other hardware that operates software to control and process information. The processor 122 executes software stored on the memory 124 to perform any of the functions described herein. The processor 122 controls the operation and administration of the network controller 102, access point 104, and/or device 106 by processing information (e.g., information received from the memory 124 and radios 126). The processor 122 is not limited to a single processing device and may encompass multiple processing devices contained in the same device or computer or distributed across multiple devices or computers. The processor 122 is considered to perform a set of functions or actions if the multiple processing devices collectively perform the set of functions or actions, even if different processing devices perform different functions or actions in the set.

The memory 124 may store, either permanently or temporarily, data, operational software, or other information for the processor 122. The memory 124 may include any one or a combination of volatile or non-volatile local or remote devices suitable for storing information. For example, the memory 124 may include random access memory (RAM), read only memory (ROM), magnetic storage devices, optical storage devices, or any other suitable information storage device or a combination of these devices. The software represents any suitable set of instructions, logic, or code embodied in a computer-readable storage medium. For example, the software may be embodied in the memory 124, a disk, a CD, or a flash drive. In particular embodiments, the software may include an application executable by the processor 122 to perform one or more of the functions described herein. The memory 124 is not limited to a single memory and may encompass multiple memories contained in the same device or computer or distributed across multiple devices or computers. The memory 124 is considered to store a set of data, operational software, or information if the multiple memories collectively store the set of data, operational software, or information, even if different memories store different portions of the data, operational software, or information in the set.

The radios 126 may communicate messages or information using different communication technologies. For example, the network controller 102, access point 104, and/or device 106 may use one or more of the radios 126 for Wi-Fi communications. The network controller 102, access point 104, and/or device 106 may use one or more of the radios 126 to transmit messages and one or more of the radios 126 to receive messages. The network controller 102, access point 104, and/or device 106 may include any number of radios 126 to communicate using any number of communication technologies.

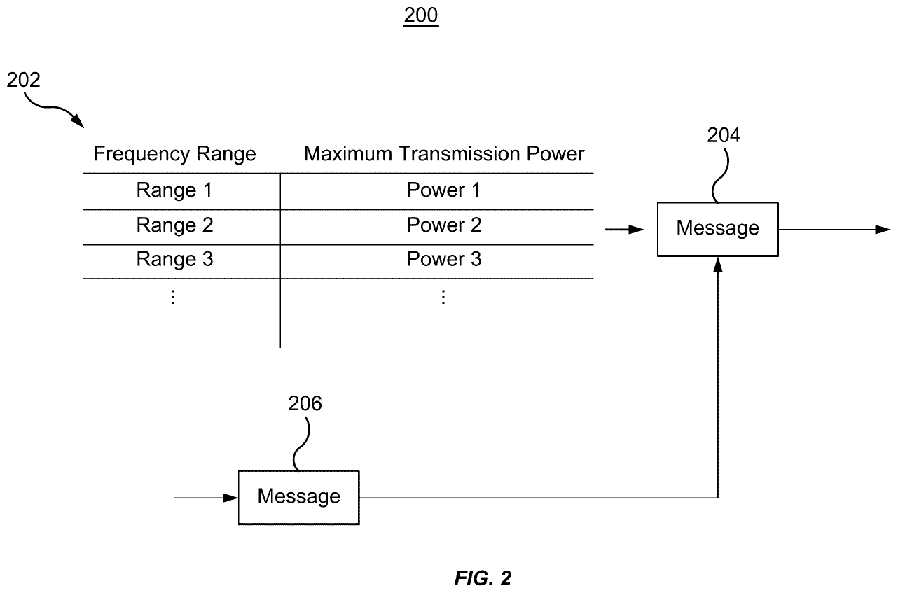

FIG. 2 illustrates an example operation 200 performed by the system 100 of FIG. 1A. In some embodiments, a network device (e.g., the network controller 102 shown in FIG. 1A or the access point 104 shown in FIG. 1A) performs the operation 200. By performing the operation 200, the network device reports allowed transmission powers for frequency ranges.

The network device begins by receiving a report 202 from an AFC system. Generally, the AFC system uses the locations of network devices in the system 100 to determine maximum transmission powers that the network devices may use for various frequency ranges to avoid interfering with incumbent devices near the network devices. In the example of FIG. 2, the report 202 indicates that the network devices may use Power 1 for Range 1, Power 2 for Range 2, and Power 3 for Range 3. The report 202 may indicate any number of maximum allowed transmission powers for any number of frequency ranges.

The range or power may be transmitted first. The range may be indicated as a starting frequency (for instance in MHz, or some linear function of that such as startingFreqIndication=floor((freqInMhz−5950)/5) or startingFreqIndication=floor((freqInMhz−5950)/freqGranularityMhz)) followed by a frequency width (where the end is determined as start+width) or an end frequency (encoded in the same way). The end of the range may be implied as the starting frequency of the next range, where the final end frequency may be signaled by an extra range or a standalone end frequency. Alternatively, an extra range standalone start frequency may be sent at the start of the message, and each extra field indicates the power and width or end frequency before which the power applies. In another embodiment, only a single starting frequency (SF) and resolution (R and/or freqGranularityMhz) is sent, followed by an array of powers, such that the nth power in the array applies to a frequency of SF+n*R. In another variation, a single end frequency (EF) is sent and the nth power in the array applies to a frequency of EF−arrayLength*R+n*R. In this embodiment, the range has width R. In some embodiments, the SF, EF, and/or R are commonly agreed values, such as being defined in a standard, and are not transmitted. Both an array of values or list of (power, frequency range) tuples may be supported such that the transmitter can select between the encoding that is shorter to send or some other metric (shortness+ease of parsing, etc.). Other similar schemes are possible also.

The network device generates a message 204 to report the allowed transmission powers to devices (e.g., the devices 106 shown in FIG. 1A). For example, the message 204 may be in an element in a beacon, a probe response, an association response frame, or an Access Network Query Protocol (ANQP)-query element in a Generic Advertisement Service (GAS) Initial Response or GAS Comeback Response frame. Generally, the message 204 may indicate several frequency ranges and the maximum allowed transmission power for each of those frequency ranges. In some embodiments, the frequency ranges in the message 204 may be less than 20 MHz. For example, each frequency range in the message 204 may be 1 MHz. As another example, each frequency range in the message 204 may be 2 MHz, 5 MHz, 10 MHz, etc. As another example the frequency range may be variable, such as 98 MHz for the first range, 10 MHz for the second range, and so forth. In this manner, the network device reports allowed transmission powers for frequency ranges at a granularity below 20 MHz. The devices that receive the message 204 may then transmit messages to the network device using the allowed transmission powers.

In some embodiments, the network device selects the frequency range granularity for the message 204 based on a message 206. The network device may receive the message 206 from a device (e.g., a device 106 shown in FIG. 1A). For example, the device may report in the message 206 a frequency range granularity (R aka freqGranularityMhz) supported by the device. The network device may then report, in the message 204, the maximum allowed transmission powers for frequency ranges at the supported granularity. In this manner, the network device avoids reporting allowed transmission powers at a frequency range granularity that is unsupported by the device.

As another example, the message 206 may request power budgets for various frequency ranges. These frequency ranges may be in different frequency bands (e.g., 2.4 GHz band, 5 GHz band, 6 GHz band, etc.). For example, the device may communicate the message 206 to the network device using a particular frequency band (e.g., 2.4 GHz band), and the message 206 may request power budgets for frequency ranges at, adjacent, to or outside that frequency band (e.g., frequency ranges from 2.4 to 2.4835 GHz (or rounded to 2.483 or 2.484 MHz), from 2.3 to 2.6 GHz, or in the 5GHz or 6 GHz bands). The frequency ranges may be signaling via a starting frequency and width, or starting frequency and end frequency, with a signaled or agreed units and offset. The frequency ranges may be signaling via a selector into a table of agreed frequency ranges. In response, the network device may include, in the message 204, allowed transmission powers for the frequency ranges indicated by the message 206. In this manner, the network device reports allowed transmission powers for any frequency range, even frequency ranges outside the frequency band used to communicate the message 206.

The message 206 may indicate frequency ranges in any manner. For example, the message 206 may request power budgets for all usable frequency ranges. As another example, the message 206 may request power budgets for a specific frequency band. As another example, the message 206 may request power budgets for a specific frequency band and frequencies near the frequency band. As another example, the message 206 may request power budgets for a specific frequency range. As another example, the message 206 may request power budgets for a specific channel and/or nearby channels or frequencies.

The message 206 may not necessarily indicate frequency ranges with the same frequency range granularity as in the message 204. For example, the device may use the message 206 to request a power budget for a 25 MHz frequency range. The network device may still report the allowed transmission powers at a frequency range granularity below 20 MHz. For example, the network device may report allowed transmission powers for frequency ranges within that 25 MHz frequency range with a 1 MHz, 2 MHz, 5 MHz, etc. frequency range granularity. As a result, the network device may report allowed transmission powers for frequency ranges that fall within the frequency range specified in the message 206.

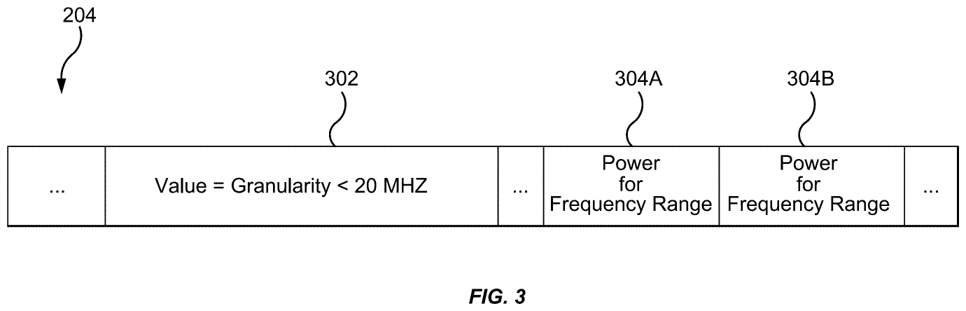

FIG. 3 illustrates an example message 204 in the system 100 of FIG. 1A. Generally, the network device generates the message 204 to report allowed transmission powers for various frequency ranges at a frequency range granularity below 20 MHz. As seen in FIG. 3, the message 204 includes several fields. In a field 302, the message 204 includes field value that indicates that the message 204 supports allowed transmission powers using a frequency range granularity below 20 MHz. In some embodiments, the field 302 may include a field value that indicates the frequency range granularity, which may be below 20 MHz (e.g., 1 MHz).

The message 204 also includes additional fields 304 for reporting allowed transmission powers for different frequency ranges. Each field 304 may include values that indicate an allowed transmission power and/or a frequency range for the allowed transmission power. In some embodiments, one or more of the fields 304 may indicate a frequency range with a width below 20 MHz. In the example of FIG. 3, the message 204 includes a field 304A and a field 304B. The field 304A and the field 304B may indicate allowed transmission powers for different frequency ranges. The fields 304A and 304B may indicate different allowed transmission powers.

The range or power may be transmitted first. The range may be indicated as a starting frequency (for instance in MHz, or some linear function of that such as startingFreqIndication=floor((freqInMhz−5950)/5) or startingFreqIndication=floor((freqInMhz−5950)/freqGranularityMhz)) followed by a frequency width (where the end is determined as start+width) or an end frequency (encoded in the same way). The end of the range may be implied as the starting frequency of the next range, where the final end frequency may be signaled by an extra range or a standalone end frequency. Alternatively, an extra range standalone start frequency may be sent at the start of the message, and each extra field indicates the power and width or end frequency before which the power applies. In another embodiment, only a single starting frequency (SF) and resolution (R and/or freqGranularityMhz) is sent, followed by an array of powers, such that the nth power in the array applies to a frequency of SF+n*R. In another variation, a single end frequency (EF) is sent and the nth power in the array applies to a frequency of EF−arrayLength*R+n*R. In this embodiment, the range has width R. In some embodiments, the SF, EF, and/or R are commonly agreed values, such as being defined in a standard, and are not transmitted. Both an array of values or list of (power, frequency range) tuples may be supported such that the transmitter can select between the encoding that is shorter to send or some other metric (shortness+ease of parsing, etc.). Other similar schemes are possible also.

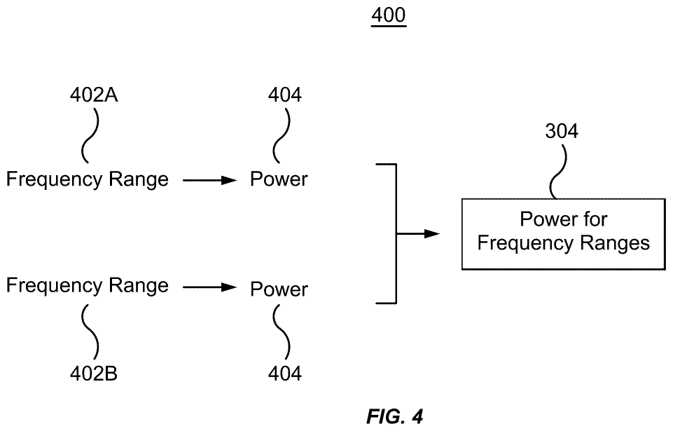

FIG. 4 illustrates an example operation 400 performed by the system 100 of FIG. 1A. In some embodiments, a network device (e.g., the network controller 102 shown in FIG. 1A or the access point 104 shown in FIG. 1A) performs the operation 400. By performing the operation 400, the network device generates a field to report allowed transmission powers for multiple frequency ranges.

The network device begins by determining allowed transmission powers for multiple frequency ranges. For example, the network device may determine the allowed transmission powers using an AFC system. In the example of FIG. 4, the network device determines transmission powers for a frequency range 402A and a frequency range 402B. The network device determines the same allowed transmission power 404 for both the frequency range 402A and 402B. Additionally, the network device may determine that the frequency range 402A is adjacent to the frequency range 402B. For example, the frequencies in the frequency range 402B may be sequential to or follow the frequencies in the frequency range 402A.

Because the frequency ranges 402A and 402B are adjacent to each other and because the frequency ranges 402A and 402B have the same allowed transmission power 404, the network device may combine the reporting of the allowed transmission power 404 for the frequency ranges 402A and 402B into a single field 304. As seen in FIG. 4, the network device generates the field 304 to include values that indicate the transmission power 404 and the (combined frequency range for) frequency ranges 402A and 402B. The network device may then include the field 304 into a message transmitted to devices to report the transmission power 404 for the frequency ranges 402A and 402B (or the combined frequency range for the frequency ranges 402A and 402B). In this manner, the network device may shorten the message relative to a message that uses separate fields to report the allowed transmission power 404 for the frequency ranges 402A and 402B.

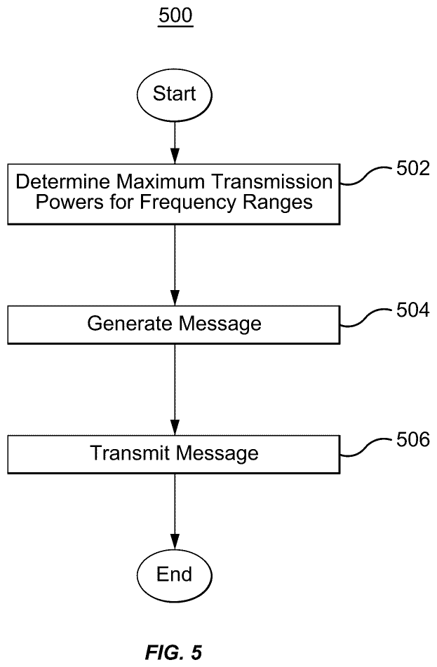

FIG. 5 is a flowchart of an example method 500 performed by the system 100 of FIG. 1A. In particular embodiments, a network device (e.g., the network controller 102 shown in FIG. 1A or the access point 104 shown in FIG. 1A) performs the operation 400. By performing the method 500, the network device reports allowed transmission powers with a frequency range granularity below 20 MHz.

At 502, the network device determines maximum transmission powers for frequency ranges. The network device may determine the maximum transmission powers from an AFC system. For example, the AFC system may report, to the network device, the maximum allowed transmission powers for various frequency ranges. Using these transmission powers at these frequency ranges may avoid interfering with incumbent devices in the vicinity of the network device.

At 504, the network device generates a message to report the allowed transmission powers. The message may include a field that indicates that the message supports allowed transmission powers with a frequency range granularity below 20 MHz. For example, the field may include a value that indicates a frequency range granularity that is less than 20 MHz (e.g., 1 MHz). The message may also include additional fields that include values that indicate the allowed transmission powers and the corresponding frequency ranges. These frequency ranges may have widths at the frequency range granularity.

At 506, the network device transmits the message to a device. In this manner, the network device reports, to the device, the allowed transmission powers for various frequency ranges. In some embodiments, because the network device reports the allowed transmission powers using a frequency range granularity below 20 MHz, the network device may allow the device to use higher transmission powers for certain frequency ranges relative to existing systems. As a result, the device may transmit messages using higher transmission power for certain frequency ranges.

In summary, a wireless network reports allowed transmission powers for frequency ranges at a granularity below 20 MHz. For example, the wireless network may report allowed transmission powers for frequency ranges at a granularity of 1 MHz. The wireless network may receive allowed transmission powers for frequency ranges from an AFC system. The wireless network may then generate a message that includes a field value that indicates that the wireless network is reporting allowed transmission powers for frequency ranges at a granularity less than 20 MHz. The message may also include the allowed transmission powers for certain frequency ranges. The wireless network may transmit the message to devices to inform the devices of the allowed transmission powers on the wireless network.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A network device comprising:
one or more memories; and
one or more processors communicatively coupled to the one or more memories, the one or more processors configured to, individually or collectively:
determine a plurality of maximum transmission powers for a plurality of frequency ranges;
generate a first message comprising (i) a field value indicating that the first message supports transmission powers for wireless transmissions for frequency ranges at a granularity below twenty MegaHertz (MHz) and (ii) a first maximum transmission power from the plurality of maximum transmission powers for a first frequency range at the granularity; and
wirelessly transmit the first message.

2. The network device of claim 1, wherein the granularity is one MHz.

3. The network device of claim 1, wherein the first message further comprises a second maximum transmission power from the plurality of maximum transmission powers for a second frequency range comprising a third frequency range at the granularity and a fourth frequency range at the granularity and adjacent to the third frequency range based on determining that maximum transmission powers of the plurality of maximum transmission powers for the third frequency range and the fourth frequency range are equal.

4. The network device of claim 1, wherein the first message comprises an array of powers comprising the first maximum transmission power.

5. The network device of claim 1, wherein the one or more processors are configured to, individually or collectively, receive a client message from a client device indicating that the client device supports the granularity and wherein the first message is transmitted to the client device in response to the client message.

6. The network device of claim 1, wherein the first message is contained in at least one of a Beacon, a Probe Response, an Association Response, a Generic Advertisement Service (GAS) Initial Response, or a GAS Comeback Response.

7. The network device of claim 1, wherein the first message comprises a second maximum transmission power from the plurality of maximum transmission powers for a second frequency range in a different frequency band than the first frequency range.

8. The network device of claim 1, wherein the one or more processors are configured to, individually or collectively, receive a second message from a client device indicating a second frequency range and wherein the first frequency range is within the second frequency range or the same as the second frequency range.

9. A method comprising:
determining a plurality of maximum transmission powers for a plurality of frequency ranges;
generating a first message comprising (i) a field value indicating that the first message supports transmission powers for wireless transmissions for frequency ranges at a granularity below twenty MHz and (ii) a first maximum transmission power from the plurality of maximum transmission powers for a first frequency range at the granularity; and
wirelessly transmitting the first message.

10. The method of claim 9, wherein the granularity is one MHz.

11. The method of claim 9, wherein the first message further comprises a second maximum transmission power from the plurality of maximum transmission powers for a second frequency range comprising a third frequency range at the granularity and a fourth frequency range at the granularity and adjacent to the third frequency range based on determining that maximum transmission powers of the plurality of maximum transmission powers for the third frequency range and the fourth frequency range are equal.

12. The method of claim 9, further comprising receiving a client message from a client device indicating that the client device supports the granularity and wherein the first message is transmitted to the client device in response to the client message.

13. The method of claim 9, wherein the first message is contained in at least one of a Beacon, a Probe Response, or an Association Response, a GAS Initial Response, or a GAS Comeback Response.

14. The method of claim 9, wherein the first message comprises a second maximum transmission power from the plurality of maximum transmission powers for a second frequency range in a different frequency band than the first frequency range.

15. The method of claim 9, further comprising receiving a second message from a client device indicating a second frequency range and wherein the first frequency range is within the second frequency range or the same as the second frequency range.

16. A non-transitory computer readable medium storing instructions that, when executed by one or more processors, cause the one or more processors to, individually or collectively:
determine a plurality of maximum transmission powers for wireless transmissions for a plurality of frequency ranges;
generate a first message comprising (i) a field value indicating that the first message supports transmission powers for frequency ranges at a granularity below twenty MHz and (ii) a first maximum transmission power from the plurality of maximum transmission powers for a first frequency range at the granularity; and
wirelessly transmit the first message.

17. The medium of claim 16, wherein the granularity is one MHz.

18. The medium of claim 16, wherein the first message further comprises a second maximum transmission power from the plurality of maximum transmission powers for a second frequency range comprising a third frequency range at the granularity and a fourth frequency range at the granularity and adjacent to the third frequency range based on determining that maximum transmission powers of the plurality of maximum transmission powers for the third frequency range and the fourth frequency range are equal.

19. The medium of claim 16, wherein the instructions further cause the one or more processors to, individually or collectively, receive a client message from a client device indicating that the client device supports the granularity and wherein the first message is transmitted to the client device in response to the client message.

20. The medium of claim 16, wherein the first message comprises a second maximum transmission power from the plurality of maximum transmission powers for a second frequency range in a different frequency band than the first frequency range.
